(19) United States
(12) Patent Application Publication
(10) Pub. No.: US 2011/0016523 A1
(43) Pub. Date: Jan. 20, 2011

(54) APPARATUS AND METHOD FOR DETECTING DISTRIBUTED DENIAL OF SERVICE ATTACK

(75) Inventors: Jintae Oh, Daejeon (KR); YouRi Lee, Daejeon (KR); Yang-Seo Choi, Daejeon (KR); Jong Soo Jang, Daejeon (KR)

Correspondence Address: AMPACC Law Group, PLLC, 6100 219th Street SW, Suite 580, Mountlake Terrace, WA, 98043, US

(73) Assignee: Electronics and Telecommunications Research Institute, Daejeon (KR)

(21) Appl. No.: 12/633,121

(22) Filed: Dec. 8, 2009

(30) Foreign Application Priority Data
Jul. 14, 2009 (KR) 10-2009-0064016
Sep. 1, 2009 (KR) 10-2009-0081900

(51) Int. Cl. G06F 11/30; G06F 15/16

(52) U.S. Cl. 726/22; 709/203

(57) ABSTRACT

An apparatus for detecting a distributed denial of service (DDoS) attack includes: a monitoring unit for monitoring multiple GET requests and responses transmitted and received depending on a session establishment between a client and a server; and an attack detection unit for analyzing the monitored multiple GET requests and responses between the client and the server to detect a traffic of the DDoS attack against the server.

### CROSS-REFERENCE(S) TO RELATED APPLICATION(S)

The present invention claims priority of Korean Patent Applications No. 10-2009-0064016, filed on Jul. 14, 2009, and No. 10-2009-0081900, filed on Sep. 1, 2009, which are incorporated herein by reference.

### FIELD OF THE INVENTION

The present invention relates to a defense against a distributed denial of service (hereinafter, DDoS) attack, and, more particularly, to an apparatus and method for detecting DDoS attack based on HTTP 1.1 protocol, which is capable of easily detecting the DDoS attack of repeatedly making GET requests through a single session in an application layer of a server on a network including a plurality of clients and the server allowing multiple GET requests.

### BACKGROUND OF THE INVENTION

Recently, due to development of network technologies, various services such as web services can be provided over the Internet. However, various attacks against a network based on the developed network technologies have been also enhanced and are frequently attempted. Particularly, strong hacking or attacks may be easily attempted by anybody as various hacking tools are developed and distributed by experts. In the past, the attacks were just ostentatious display, but in present, the attacks are attempted to make money, thereby becoming even more serious problem.

A recent DDoS attack as one of the attacks against a network has been attempted using malware such as Bot such that a server that is the most important thing of enterprises cannot provide services.

In order to respond to the DDoS attack, several detecting and coping techniques have been developed. Most of the techniques provide a method of detecting network level-DDoS attacks such as SYN flooding based on traffic volume. However, application layer-DDoS attack does not generate a mass of traffics and thus the detecting techniques based on the traffic volume are not enough to detect the DDoS attack which disturbs application layer services of a server.

In other words, in most current methods proposed to cope with the DDoS attack, the DDoS attack is merely moderated by reducing the amount of traffics inputted to the server as in a rate limiting technique. Thus, there is no fundamental technology of detecting and blocking the DDoS attack packet itself or an IP (internet protocol) of an attacker.

In this circumstance, from using HTTP 1.1 protocol, it became possible to connect one session using a persistent connection maintaining function and then transmit GET packets for requesting multiple URIs to the server. That is, the HTTP 1.1 protocol allows the persistent connection maintaining function and, in this case, a multiple HTTP GET requests are allowed in one session and a pipelined GET request is also enabled.

FIG. 1 shows a signal flow when a client makes multiple GET requests through a connection of a single session to a server that supports HTTP 1.1 protocol.

First, a client 100 transmits an SYN packet for requesting session connection to a server 110 in order to request services in step S100. The server 110 responds to the transmitted SYN packet with an SYN+ACK packet when a resource is allowed in step S102. Then, the client 100, which has received the SYN+ACK packet transmitted from the server 110, sends an ACK packet to the server 110 in step S104, and thus a new session is established.

In this manner, after the session between the client 100 and the server 100 is established, the client 100 sends a GET packet for requesting a desired web page to the server 110 in step S106. Then, the server 110 receives the GET packet transmitted from the client 100 and delivers data corresponding to the GET packet as a response packet in step S108. The client 100, in step S110, transmits on occasion an ACK packet as a response that the response packet transmitted from the server 110 has been received.

For example, if the client 100 inputs ‘www.ddos.com’ in an input window of a web browser so as to access the web site named by www.ddos.com, the steps S100 to S104, which are a process of connecting a session, are performed. After that, the client 100 makes a GET request for a main page of the www.ddos.com through the connected session.

In general, a single web page is displayed on a web browser by multiple GET requests. For example, when a main page is requested, information such as a script, an image file, and uniform resource identifier (URI), which constitute the main page, is delivered to the client 100, and thus the client 100 may request continuous data using the information.

That is, an additional GET request packet is delivered to the server 110. As such, the client 100 may know a subsequent data to request only after having completely received the main page of www.ddos.com by the first GET packet. The additional request for the subsequent data is generated in form of continuous GET request as in steps S112 and S114 shown in FIG. 1, and response packets are received as a response of the server 110 to the additional requests in steps S116 and S118.

As described with reference to FIG. 1, in the HTTP 1.1 protocol-based server, a drawback that a session connection has to be repeatedly established to the same server is overcome by the persistent connection maintaining function, so that the number of session connections to the server is reduced. However, in such a server, the DDoS attack such as HTTP GET flooding or CC flooding of repeatedly requesting various URIs in a single connection is also enabled.

For example, if it is assumed that www.ddos.com is constituted of 50 URIs, all URIs can be requested in a single session. Thus, it is possible that an attacker connects a single session and then repeatedly requests 50 URIs to make an attack such that the server cannot provide normal services.

In HTTP 1.0 protocol in the past, since all GET requests were made by creating a new session, multiple GET requests led to requests for multiple session connection. In HTTP 1.1 protocol, however, since multiple GET requests are enabled by connecting only a single session, it is difficult to distinguish a normal user's request for services from an attacker's request which prevents the server from providing normal services.

In order to solve the problem in the HTTP 1.1 protocol, a conventional method of detecting DDoS attack in which each host counts the number of GET packets generated per unit time and detects an attack host depending on whether the counted number exceeds a predetermined threshold value has been proposed. However, in the conventional method, different threshold values must be set to respective servers based on performances of the servers and complexities of web pages and it is not easy to detect the DDoS attack. In addition, when the threshold value for detecting the DDoS attack is set wrong to the server, miss-detection of the DDoS attack occurs and a traffic of a normal user may be rather blocked.

### SUMMARY OF THE INVENTION

In view of the above, the present invention provides an apparatus and method for detecting DDoS attack based on HTTP 1.1 protocol, which can easily detect DDoS attack of repeatedly making GET requests through a single session in an application layer of a server on a network including the server allowing multiple GET requests using a persistent connection maintaining function and a plurality of clients, in a manner that detects as a traffic of the DDoS attack a traffic of transmitting another GET request before a response from the server is completed by monitoring the order of GET requests from the clients and response packets from the server.

In accordance with a first aspect of the present invention, there is provided an apparatus for detecting a distributed denial of service (DDoS) attack, including:

a monitoring unit for monitoring multiple GET requests and responses transmitted and received depending on a session establishment between a client and a server; and

an attack detection unit for analyzing the monitored multiple GET requests and responses between the client and the server to detect a traffic of the DDoS attack against the server.

In accordance with a second aspect of the present invention, there is provided a method for detecting a distributed denial of service (DDoS) attack, including:

establishing a session between a client and a server;

analyzing multiple GET requests and responses transmitted and received between the client and the server after the session is established; and

detecting a traffic of the DDoS attack against the server based on the analysis result.

### BRIEF DESCRIPTION OF THE DRAWINGS

The above features of the present invention will become apparent from the following description of preferred embodiments given in conjunction with the accompanying drawings, in which:

FIG. 1 shows a view illustrating a signal flow between a client and a server based on HTTP 1.1 protocol;

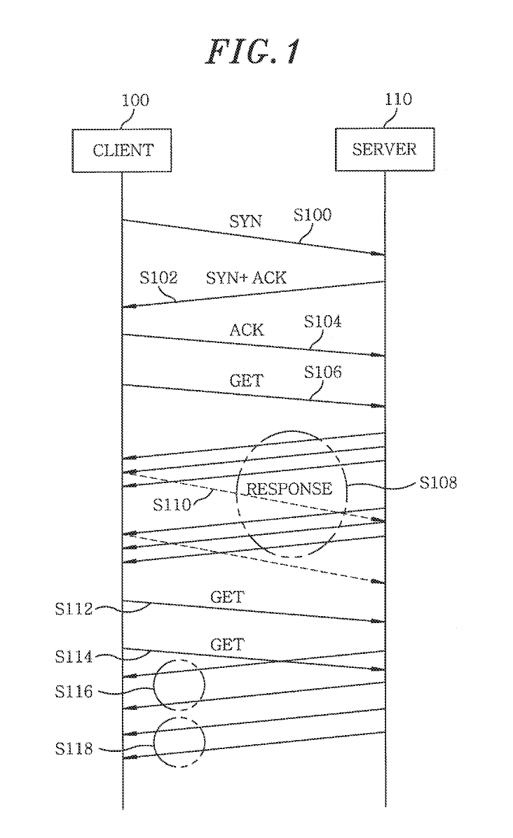

FIG. 2 illustrates the configuration of an apparatus and a network for detecting DDoS attack in a server based on HTTP 1.1 in accordance with an embodiment of the present invention; and

FIG. 3 is a view showing a signal flow between a client and a server, which contains DDoS attack, in the server based on HTTP 1.1 in accordance with an embodiment of the present invention.

### DETAILED DESCRIPTION OF THE EMBODIMENTS

Hereinafter, embodiments of the present invention will be described in detail with the accompanying drawings.

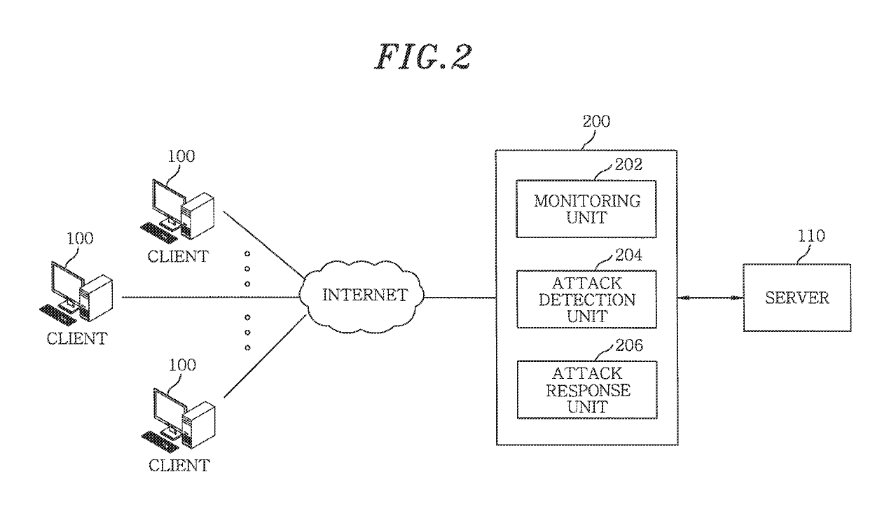

FIG. 2 shows a configuration of an apparatus for detecting a distributed denial of service (DDoS) attack in a HTTP 1.1 protocol-based server supporting multiple GET requests in accordance with an embodiment of the present invention and a configuration of a network.

Referring to FIG. 2, a client 100 may be an interface terminal such as a personal computer (PC), which can be connected to a network such as the Internet. The client 100 may be connected to a web server 110 which the client 100 wants to access, for example, www.ddos.com, over the Internet. Since the server 110 supports HTTP 1.1 protocol, the client 100 can transmit multiple GET requests to the server 110 using a persistent connection maintaining function supported by HTTP 1.1 protocol after establishing a session with the server 110.

When there are requests for session establishment from a plurality of clients 100 connected through a network such as the Internet, the server 110 establishes a session by exchanging packets for the session establishment with the clients 100. The server 110 provides the persistent connection maintaining function supported by HTTP 1.1 protocol to thereby receive multiple GET requests transmitted from the clients 100 and transmit response packets to the GET requests. That is, the server 110 receives GET packet for requesting a webpage or the like from the clients 100 and transmits corresponding data on the requested webpage or the like. Here, the server 110 responds with a plurality of response packets to one GET request from the client 100. Through the above process, the client 100 can be provided with a desired service.

An apparatus 200 for detecting DDoS attack detects DDoS attack against the server 110, which is delivered by the clients 100, in a manner that detects a traffic which is transmitting another GET request in a state that a response, i.e., a plurality of response packets, from the server 110 is not completed as a traffic of the DDoS attack, by analyzing the order of multiple GET requests from the clients 100 and response packets from the server 110.

In more detail, in order to detect the DDoS attack, a monitoring unit 202 of the apparatus 200 monitors a flow of the multiple GET requests from the respective clients 100 and corresponding response packets from the server 110.

An attack detection unit 204 receives, from the monitoring unit 202, information on the flow of the multiple GET requests and the corresponding response packets transmitted and received between the clients 100 and the server 110, and then analyzes the order of the GET requests and the response packets to thereby detect the DDoS attack.

In general, a normal client 100 may know a homepage URL or the like of the server 110 but cannot know elements of the web page. This is because the elements are collected by response packets of a first GET request of the client 100. Based on the collected elements, the client 100 gets elements of a subsequent web page by transmitting another GET request in the same session. However, a client 100 of an attacker performing the DDoS attack makes a second GET request before a response to the first GET request is completed. The second GET request is an unacceptable action which neglects a principle of nobody predicting the future and is generated only by the attacker.

Therefore, the attack detection unit 204 may detect as the DDoS attack a case where a second GET request is generated by a client 100 before a response to a first GET request from the client 100 is completed by a server 110.

When a traffic from the client 100 is detected as the DDoS attack, an attack response unit 206 responds to the traffic using an existing method such as IP block, rerouting, packet drop and the like.

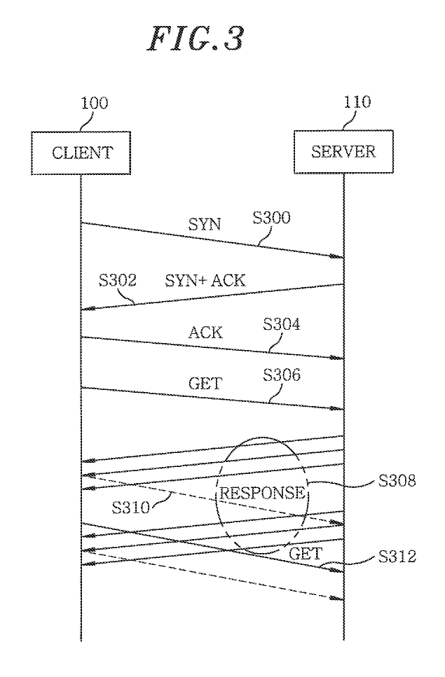

FIG. 3 shows a signal flow of GET requests and responses between a HTTP 1.1 protocol-based server and a client in accordance with the embodiment of the present invention.

First, the client 100 requests a session connection by transmitting an SYN packet to the server 110 to request a service in step S300. Then, the server 110 responds to the SYN packet transmitted by the client 100 with an SYN+ACK packet when a resource is allowed in step S302. Thereafter, the client 100 which has received the SYN+ACK packet transmitted from the server 110 transmits an ACK packet to the server 110 in step S304, and thus a new single session is established between the client 100 and the server 110.

In this way, after the session is established between the client 100 and the server 110, the client 100 requests a desired web page to the server 110 by transmitting a GET packet in step S306. Then, the server 110 which has received the GET packet from the client 100 delivers data corresponding to the GET packet as response packets in step S308. The client 100 transmits to the server 110 on occasion an ACK packet as a response of having received the response packets transmitted from the server 110 in step S310.

For example, if the client 100 inputs ‘www.ddos.com’ in an input window of a web browser so as to access the web site named by www.ddos.com, the steps S300 to S304, which is a process of connecting the session, are performed. After that, the client 100 makes a GET request for a main page of www.ddos.com through the connected session in step S306 and then receives response packets transmitted from the server 110 in step S308 to thereby obtain desired results sequentially.

The traffic of the client 100 cannot be determined whether it is a traffic by a normal client or by the DDoS attack, only through the monitoring of the GET request and the response packets between the client 100 and the server 110 in the above steps S300 to S310.

However, as seen in step S312, the client 100 makes another GET request before the response packets of the server 110 in step S308 are completely received.

This request may be appeared as a normal request under the circumstance where multiple GET requests are allowed using the session connection maintaining function based on HTTP 1.1 protocol. However, the request is an abnormal request which cannot occur in a regular service situation. This is because the client 100 can obtain information on a URI or an image file which is subject to an additional GET request only when the client 100 has completely received response packets from the server 110 to the first GET request after the session is connected between the client 100 and the server 110.

Therefore, since the GET request by the client 100 in step S312 is made in a situation where the client 100 already knows specific information which can be obtained only after a response from the server 110 has been completed in step S308, the GET request cannot be made in normal traffics.

Thus, in case where the server 110 receives the second GET request from the client 100 in step S312 before the client 100 completely receives response packets from the server 110 in step S308 to the first GET request from itself in step S306, this may be detected as the DDoS attack.

The monitoring unit 202 of the apparatus 200 for detecting DDoS attack monitors the order of transmission and reception of the GET requests and the response packets that are generated between the client 100 and the server 110, and provides the monitoring information to the attack detection unit 204.

Then, the attack detection unit 204 analyzes the order of the transmission and reception of the GET requests and the response packets between the client 100 and the server 110 monitored by the monitoring unit 202 and detects as a DDoS attack a case where a second GET request is received from the client 100 in step S312 before the client 100 completely receives response packets from the server 110 in step S308 to the first GET request in step S306.

When the traffic of the client 100 is detected as the DDoS attack, the attack response unit 206 responds to the traffic using an existing method such as IP block, rerouting, packet drop and the like.

As described above, the present invention may easily detect the DDoS attack of repeatedly making GET requests through a single session on a network including HTTP 1.1 protocol-based server and a plurality of clients, in manner that determines as a traffic of the DDoS attack a traffic of transmitting another GET request before a response from the server is received by monitoring the order of the GET requests from the clients and response packets from the server.

Accordingly, it is possible to detect an attacker who attempts a DDoS attack without using an unclear element such as a threshold value and to require no learning on how to distinguish an attacker and a normal user. That is, if it is checked that the time when a response from the server to a first GET request of the client is generated and the time when a second GET request is generated by the client, the DDoS attack can be instantly detected, thereby coping with the DDoS attack by checking the attacker's IP.

While the invention has been shown and described with respect to the embodiments, it will be understood by those skilled in the art that various changes and modification may be made without departing from the scope of the invention as defined in the following claims.

What is claimed is:

1. An apparatus for detecting a distributed denial of service (DDoS) attack, comprising:
a monitoring unit for monitoring multiple GET requests and responses transmitted and received depending on a session establishment between a client and a server; and
an attack detection unit for analyzing the monitored multiple GET requests and responses between the client and the server to detect a traffic of the DDoS attack against the server.

2. The apparatus of claim 1, wherein the client transmits the multiple GET requests to the server to request services after the session is established.

3. The apparatus of claim 2, wherein the server transmits data corresponding to the respective GET requests to the client in response to the GET requests received from the client after the session is established.

4. The apparatus of claim 1, further comprising an attack response unit for responding to the traffic of the DDoS attack detected by the attack detection unit.

5. The apparatus of claim 1, wherein the multiple GET requests are made based on HTTP 1.1 protocol.

6. The apparatus of claim 5, wherein the server supports HTTP 1.1 protocol.

7. The apparatus of claim 1, wherein the DDoS attack corresponds to an attack of HTTP GET flooding type.

8. A method for detecting a distributed denial of service (DDoS) attack, comprising:
establishing a session between a client and a server;
analyzing multiple GET requests and responses transmitted and received between the client and the server after the session is established; and
detecting a traffic of the DDoS attack against the server based on the analysis result.

9. The method of claim 8, wherein said detecting the traffic of the DDoS attack includes:
monitoring the multiple GET requests transmitted from the client to the server;
monitoring the responses of the server to the multiple GET requests;
checking through the monitoring whether a second GET request is generated again from the client before responses from the server to a first GET request of the client are completed; and
detecting as the DDoS attack a case where the second GET request is generated by the client before the response from the server to the first GET request of the client is completed.

10. The method of claim 8, wherein the client transmits the multiple GET requests to the server to request services after said establishing the session.

11. The method of claim 10, wherein the server transmits data corresponding to the respective GET requests to the client in response to the GET requests received from the client after said establishing a session.

12. The method of claim 8, further comprising, after said detecting the traffic of the DDoS attack, responding to the traffic from the client detected as the DDoS attack.

13. The method of claim 8, wherein the multiple GET requests are made based on HTTP 1.1 protocol.

14. The method of claim 8, wherein the server supports HTTP 1.1 protocol.

15. The method of claim 8, wherein the DDoS attack corresponds to an attack of HTTP GET flooding type.
